(19) United States
(12) Patent Application Publication
(10) Pub. No.: US 2014/0293266 A1
(43) Pub. Date: Oct. 2, 2014

(54) Local Alignment and Positioning Device and Method

(71) Applicants: Ying Hsu, San Clemente, CA (US); David Ludwig, Irvine, CA (US)

(72) Inventors: Ying Hsu, San Clemente, CA (US); David Ludwig, Irvine, CA (US)

(21) Appl. No.: 13/567,277

(22) Filed: Aug. 6, 2012

Related U.S. Application Data
(60) Provisional application No. 61/515,193, filed on Aug. 4, 2011.
(60) Provisional application No. 61/601,854, filed on Feb. 22, 2012.

(51) Int. Cl. G01S 17/48

(52) U.S. Cl. CPC G01S 17/48
USPC 356/5.01

(57) ABSTRACT

A device and method that uses terrain features having one or more predetermined characteristics or weights in an electronic image date frame or set of frames such as a LIDAR voxel set of image data frames for use as system reference points which are, in turn, used in one or more trilateration calculations performed in electronic circuitry to determine a position or ego-motion of the device.

### CROSS-REFERENCE TO RELATED APPLICATIONS

This application claims the benefit of U.S. Provisional Patent Application No. 61/515,193, filed on Aug. 4, 2011, entitled “Ground Tracking Orientation System” pursuant to 35 USC 119, which application is incorporated fully herein by reference.

This application claims the benefit of U.S. Provisional Patent Application No. 61/601,854, filed on Feb. 22, 2012, entitled “GPS-Independent Local Alignment and Positioning Device and Method” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of electronic imaging devices and positioning devices. More specifically, the invention relates to a tracking and motion sensing device and method that uses terrain features having one or more predetermined characteristics or weights in an electronic image data frame or set of images, as reference points which are, in turn, used in one or more trilateration calculations to determine position or ego-motion of the system.

2. Description of the Related Art

Military and commercial users seek a navigation sensor technology for determining the position and orientation (six degree of freedom) of, for instance, vehicles, aircraft or soldier weapon systems. The system must be capable of determining absolute heading, operate with low power, be relatively small and lightweight and require no calibration.

There is a related need for determining precise target geo-locations from Unmanned Aerial Systems (UAS) operating in GPS-denied or GPS-degraded environments. When guided solely by inertial sensors, accumulated drift errors for long-loitered UAS quickly become large and unacceptable.

To overcome the above deficiencies in the prior art, the instant invention exploits the fact the rate of error in the inertial navigation system can be bounded within an acceptable level by integrating prior art inertial sensors with an optical sensor; both working in conjunction with estimation filters. To ensure the resulting system can be successfully fielded, any such auxiliary optical sensor must also be small, light-weight, low-power, and affordable.

Such a high-performance positioning or orientation sensor system is preferably capable of measuring an absolute heading with high accuracy of, for instance, three angular mils, perform in demanding military environments and measure orientation while undergoing slew rates in the range of 60° per second (threshold) and 360° per second (objective).

To enable mounting such a sensor system on smaller, mobile gear such as a weapon, the size of the sensor system would preferably be no larger than one inch wide by one inch high and four inches long.

Existing orientation systems include digital magnetic sensors whose accuracy are affected by nearby metal objects and which undesirably require calibration before each use.

Alternative prior art methods for measuring absolute heading include using inertial and optical sensors. Existing miniature and low-power inertial sensors, such as MEMS-based gyroscopes and accelerometers all are susceptible to drift error and generally cannot meet demanding military requirements.

Prior art optical sensors that rely on image recognition and optical flow techniques are negatively affected by shadows, sunlight reflections and problems associated with image scaling, rotation and translation. However, optical measurement techniques can be improved dramatically by using sensors capable of capturing images in three dimensions.

When invariant terrain images are obtained in three dimensions using a LIDAR system or a structured light element, clusters or pluralities of invariant ground terrain features, also referred to as reference points herein, with unique characteristics can be identified in the obtained 3-D images for tracking, positioning or ego-motion (i.e., self-motion) purpose. Exemplar terrain features may comprise, but are not limited to rocks, trees, soil variations, high contrast elements on the ground, mountains, hills, buildings, elevation differences, man-made or natural features or variations in the landscape. Since each invariant terrain feature acting as a reference point in image data is unique and can serve as a terrain signature or fingerprint, those features as reference points serve to define an invariant pattern that is easily recognized and can be used for calculating ego-motion of the imaging sensor system.

As clusters of acceptably high signal to noise ratio pixels representative of invariant features in a scene in an image data frame (represented as reference points) are tracked and move out of the imaging field, new clusters of high contrast pixels representing new invariant features in the scene replace them, providing a means for continuous tracking of the sensor's position and orientation.

An important technology for realizing the disclosed optical positioning system is the use of a miniature light detection and ranging (LIDAR) or laser detection and ranging (LADAR) system.

LIDAR is a known remote optical sensing technology commonly used for precise measurement of ranges and properties of distant targets and for generating voxel data for outputting three-dimensional images of a scene of interest. LIDAR technology has been successfully used for 3-D imaging, surveying, mapping, atmospheric research, and metrology for commercial, military and space-based applications.

Downward-looking LIDAR systems that are mounted on aircraft or UAVs have been used in conjunction with global positioning satellite systems (“GPS”) and inertial measurement units (“IMUs”) to produce high resolution and precise elevation models of natural landscape and urban structures. Similarly, space-based LIDAR systems have been deployed to obtain 3-D images of natural and man-made structures.

Related to the above deficiencies in the prior art, there is further an existing need for a navigation system for use in a UAV that can operate without GPS using a prior art inertial measurement unit (IMU) integrated with an optical position sensor that is capable of providing accurate position data for correcting an IMU's drift error.

A desirable solution would be a sensor system that functions similarly to the GPS, but instead of using a constellation of satellites for determining global geo-locations, the system would comprise multiple “virtual ground stations” that relay position and distance data to the UAS sensor to determine local geo-locations.

As set out in further detail below, the above lacking IMU/optical sensor system can be realized using LIDAR technology in the instant invention. The signals from the virtual ground stations are reflected (or back-scattered) light emanating originally from a small laser on board the UAV. Using LADAR and simple algorithms, the received signals from multiple ground spots are tracked continuously and the received signals used for calculating precise self-motion (ego-motion) and for IMU error correction.

The advent of chip-scale laser, 3-D electronics and high-speed, field-programmable gate arrays (FPGAs) now makes a low-cost and low size, weight and power (SWaP) LADAR system small, light-weight, and affordable.

The instant invention and method address these deficiencies and what is lacking in prior art positioning sensor systems and enable positioning devices that are not reliant on GPS signals.

### BRIEF SUMMARY OF THE INVENTION

The disclosed invention takes advantage of LIDAR measurement in navigation applications. The device and method provide the capability of determining position and self-motion (ego-motion) of a LIDAR system in 3-D space. In a preferred embodiment, using LIDAR range measurements and voxel data in the form of LIDAR 3-D images, the invention leverages the unique capability of LIDAR to measure range very accurately from a few meters to hundreds of kilometers.

In this embodiment, during operation the LIDAR system of the invention captures a plurality of images in a scene of interest, i.e., the surrounding terrain and terrain features and ranges thereof, to generate a detailed 3-D voxel map.

Each pixel in the scene images or image data frames contains range and 3-D information (x, y, z), thus unique features or reference points in the image data are readily identified and may be weighed using image filter algorithms to identify one or more predetermined weighing characteristics, ranked by those characteristics and then selected as reference points by the system.

Preferably, three or more high-contrast, high signal to noise terrain features are selected and are tracked continually over time. As the features represented as reference points move out of the optical field of view, new features are selected to replace exiting features in the field of view.

Next, using the ranging capability of the LIDAR, the distances of the features in the image are measured. Finally, the position of the LIDAR can be determined by trilateration of the measured ranges of the features.

The operation of the device of the invention is similar to that of the GPS but instead of measuring precise distances to a constellation of satellites with known positions, the invention measures its position relative to a group of select terrain features having well-defined 3D, high-contrast image characteristics acting as reference points that can be tracked over time as the system moves through 3-D space.

For navigation purpose, the ego-motion of the invention may be used to correct for the drift in an associated IMU in absence of GPS. For distant navigation without GPS, a survey map containing 3-D images of a vehicle path is needed. The invention can be configured to pattern-match measured 3-D targets with associated surveyed terrain features stored in computer memory and determine its geo-position. The sensor system of the invention thus can provide a low power and robust computation method for positioning and navigation in GPS-absent environments.

The disclosed invention provides many important advantages as compared to prior art vision- or RF-based navigation aiding systems. These advantages include at least the following:

Precision Geo-Location: The accuracy of calculated UAS positions depends largely on the resolution of the measured ranges between the sensor and select ground cells. Using LIDAR, the achievable range resolution (for altitudes of several hundred meters) can be less than one centimeter, yielding high precision position determination.

Invariant Image Features: The high resolution range from each voxel enables unique identification of each terrain reference point. Select features can be identified and tracked, and are invariant with respect to the receiver motion. Common problems that plague the vision- and RF-based imaging systems such as image scaling, rotation, translation and affine transformation are eliminated in the invention.

Simple (Low-Power) Computations: Conventional tracking computations require extracting both range and angles of each voxel for use in a full transformation matrix to determine the six degree-of-freedom motion. Using only range for determining locations of the sensor simplifies the computation, increases accuracy and reduces computation power and time. Most importantly, the simple computations result in a robust and stable navigation system.

Small, Compact Sensor: The size and weight of the selected embodiment of the invention are determined by a design tradeoff between laser power, receiver optics, and transceiver methodology (staring versus scanning) For low altitude (a few hundred meters) applications, a small diode laser is suitable. An analysis has shown that at an altitude of 200 meters, the largest components in the system are the imaging optics: i.e., four cm diameter and an f/2 system.

GPS-independent Navigation: In GPS-denied environments, the invention provides critical error correction to the inertial navigation system (“INS”) and limit the bias drift accumulation in IMU. The invention provides an accurate geo-position (and changes in position or velocity) to the INS estimation filter and the resulting hybrid system achieves high navigation accuracy over periods of time.

Day and Night Operations: LIDAR wavelengths are typically in the near IR (in the range of 0.8 to 1.5 μm). At these wavelengths, the sensor system can operate day or night, and through smoke and fog conditions.

All Terrain and High Altitudes Operations: With its high resolution range, the invention operates in all terrains, including areas over dense vegetation and steep terrain. Additionally, with higher laser power (or larger receiver optics), it can operate in high altitudes, up to several kilometers.

In a first aspect of the invention, a tracking and motion sensing system is provided comprising sensor and range calculating circuitry configured to detect and calculate each of a plurality of ranges relative to the sensor of each of a plurality of features in a scene where the features define each of a plurality of reference points that are representative of the features within an image data frame that is representative of the scene. Electronic trilateration calculating circuitry is provided and configured to calculate a three-dimensional point location relative to the sensor in a three-dimensional space from the plurality of reference points.

In a second aspect of the invention, the electronic trilateration calculating circuitry is further configured to calculate a sensor travel distance using at least two of the three-dimensional point locations.

In a third aspect of the invention, the sensing system comprises a time-of-flight LIDAR system.

In a fourth aspect of the invention, the sensing system comprises a phase-sensing LIDAR system.

In a fifth aspect of the invention, the sensing system comprises a structured-light three-dimensional scanning element comprising a projected light pattern source and a visible imaging camera system configured to measure a three-dimensional object.

In a sixth aspect of the invention, at least one of the reference points is selected from a plurality of weighted reference points stored in electronic memory and ranked using at least one predetermined image feature characteristic.

In a seventh aspect of the invention, the plurality of first reference points comprises at least four.

In an eighth aspect of the invention, the plurality of second reference points comprises at least four.

In a ninth aspect of the invention, the plurality of first and second reference points each comprise at least four.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts a preferred embodiment of a sensing system of the invention.

FIG. 2 depicts a sensing system block diagram of the invention.

FIG. 3 depicts a signal processing block diagram of the invention.

FIG. 4 depicts a set of trilateration calculation steps of the invention.

FIG. 5 depicts a LIDAR algorithm processing flow diagram of the invention.

FIG. 6 depicts a preferred embodiment of a stacked LIDAR receiver module of the invention.

FIG. 7 depicts the operation of a phase-sensing LIDAR system of the invention.

FIG. 8 depicts the operation of a structured light element of the invention.

FIG. 9 depicts three alternative embodiments of a phase-sensing LIDAR focal plane architecture of the invention.

FIG. 10 depicts a focal plane array unit with a micro-bolometer unit cell of the invention.

FIG. 11A depicts a structured light element sensor architecture of the invention.

FIG. 11B depicts a structured light element operational block diagram of the invention.

FIG. 12 depicts range measurement needed to compute translation of a sensor of the system of the invention.

FIG. 13 depicts range being used to calculate FPA tilt angle of the invention.

FIG. 14 depicts nadir range being used to calculate azimuth rotation of the invention.

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

LIDAR is widely used to measure precise distances of specific targets. By scanning a LIDAR in two orthogonal directions, or using a LIDAR with two-dimensional detector arrays, a 3-D image of the surrounding physical environment can be generated. Each pixel in the 3-D image has unique coordinate values of x, y and z (or range). Applicants exploit the LIDAR-generated 3-D image to determine self-position in 3-D space.

This measurement can be accomplished in a two-step process. First, unique features, such as those with high contrast ratios, are identified as reference points or targets. Second, using the range information from at least four select targets, the position of LIDAR relative to those targets can be determined by trilateration.

This technique is similar to determining the position of a vehicle using GPS, but instead of relying on signals transmitted from a constellation of satellites, this technique uses reflected laser signals from a group of unique and spatially fixed targets. The relative position as computed is accurate due to the high accuracy of LIDAR ranging, and is computationally simple (fast and low power) and robust. Once identified, the reference points are invariant and the common problems that plague the vision- and RF-based imaging systems such as image scaling, rotation, translation, and affine transformation are not applicable to this technique.

Once the unique self-position of the LIDAR is determined in 3-D space, this measurement technique can be used for navigation. By tracking the select targets in the field of view, self-movement can be determined by computing new positions from each image frame. As the targets being tracked move out of the field of view, new targets are selected and tracked. The LIDAR imaging frame rates can be up to several hundred Hz. For navigation purposes, given a map of known 3-D features and their geo-locations, this technique can be used to determine absolute positions. The LIDAR output may be also be used as an aid to the INS, whereby changes in the position can be used to correct the drift in IMU and enable short term navigation without GPS.

Turning now to the figures wherein like numerals define like elements among the several views, a local alignment and positioning tracking and motion sensing device and method are disclosed.

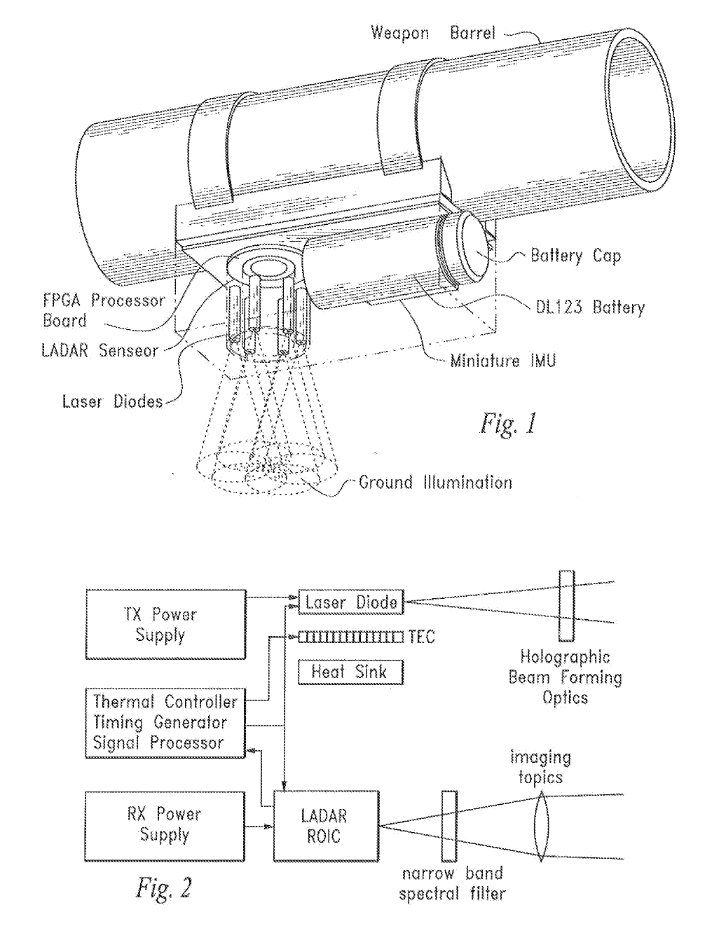

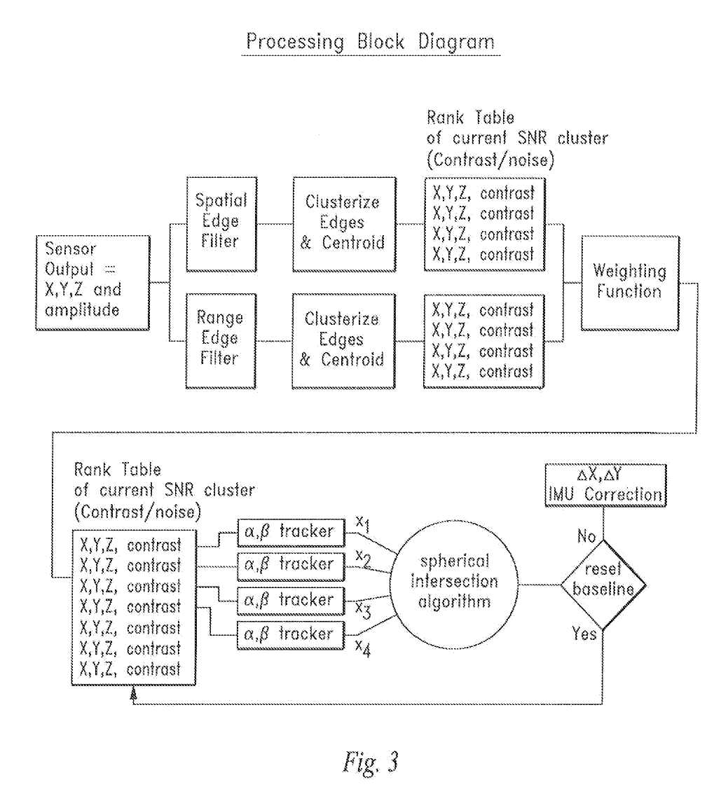

FIG. 1 depicts a preferred embodiment of a sensing system of the invention and FIG. 2 depicts a block diagram of the major elements of a preferred embodiment of the sensing system of the invention.

With respect to the embodiment of the invention depicted in FIGS. 1 and 2, a laser diode may used as a LIDAR transmitter for the illumination of the ground and terrain features in a scene of interest. The illumination generates a reflection or laser echo return from the three-dimensional surfaces of features in the scene.

As is generally known in the LIDAR arts, laser transmitter energy in a LIDAR system is optimally imaged on a scene using an optical filter, a beam-forming element or both. The scattered and reflected laser transmitter light from the ground and terrain features is collected by the LIDAR system using an imaging lens and a spectral filter, and focused onto a focal plane array (FPA) that is selected to respond to the laser transmitter wavelength and to output an electronic signal in response to the receiver laser transmitter echo.

The LIDAR imaging process may be viewed as similar to illuminating the ground and terrain features using a flashlight and collecting the time-delayed reflected light from the surface features in the scene using an imaging or focal plane array. The different distances from the imager of the surface features in the scene result in different delay times of the return echo of the illuminating signal back onto the FPA.

The laser transmitter pulses and the FPA are both triggered, i.e., initiated by the same timing generator signal at the same instant in time for each laser pulse and receive operation, referred to in the LIDAR arts as Tzero or T₀.

The transmitted laser energy is reflected from the ground and terrain features in the form of a laser echo or return that is received by the individual pixel elements on the FPA. A small array InGaAs Avalanche Photodiode Detectors (APD) is a suitable focal plane array element in a preferred embodiment of the invention.

The output of each focal plane array pixel element is processed using suitable readout electronics designed to calculate time-of-flight (“TOF”) or modulated phase differences received by the pixels in the receiving FPA between the time the laser transmitter pulse leaves the sensor system and the arrival of the laser echo on the pixels on the FPA. Through signal processing circuitry, the FPA outputs are used to define a three-dimensional voxel image map of the ground and terrain features for subsequent analysis for use as reference points representing terrain features in one or mare image date frames by the system.

Once a 3-D image voxel map representative of a set of the ground and terrain features has been constructed using suitable image processing circuitry, a plurality of ground feature reference points, preferably at least four, are selected from the image data set or sets and their movements tracked using a trilateration algorithm executed in suitable electronic circuitry.

High-resolution feature range data obtained from voxels sets (3-D pixels) makes identifying and tracking the selected reference points relatively computationally simple. Using only reference point range information, the sensor system executes an algorithm to determine each reference point location in the 3-D image frame relative to the FPA and to the remaining selected reference points.

As the sensor travels through 3-D space, such as on a UAV or vehicle, its movement may be accurately determined as long as it continues to use signals from the original selected reference points. In practice, more than four reference points in a 3-D image frame are tracked, allowing reference points exiting the frame to be excluded and new reference points in subsequent voxel frames to be selected included in calculations.

The sensor system final output may desirably be used in cooperation with electronic estimation filters for IMU error compensation.

The LIDAR sensor of the invention may comprise a laser diode as the transmitter. The laser diode preferably operates at eye-safe amplitudes above the visible spectrum and is supplied by a low voltage, high current power supply. This may be provided as a modular power supply that draws its power from the host vehicle.

The laser diode preferably fires its pulses through a holographic beam-forming optical element that controls the beam shape to match the receiver's field of view and controls the energy distribution to be a “top hat” as opposed to Gaussian, i.e., the energy is spread uniformly across the field of view. The laser diode may be temperature-stabilized to maintain the output wavelength over its operating period.

The laser pulse circuitry receives its trigger signal to pulse from a timing generator. The timing generator may be provided as part of a single printed circuit board that comprises the LIDAR transmitter (Tx) power supply, LIDAR receiver (Rx) power supply, thermo-electric cooler and controller, and signal processing circuitry. The timing generator and signal processor may be configured in an FPGA that includes an embedded ARM processor. The signal processing circuitry may be configured to process an algorithm for determining drift from the LIDAR measurements.

The receiver may comprise a small LIDAR focal plane (e.g., 8×8-128×128 pixels). This size focal plane is sufficient to determine spatial location and range for every voxel on the ground or on a terrain feature. The receiver is preferably configured with a narrow band spectral filter that only allows the wavelength of the laser transmitter to pass. The laser echo collection optics are preferably sized to capture a sufficient number of laser photons to attain an acceptably high signal-to-noise ratio in the FPA signal. In an exemplar embodiment with an expected range of about 200 meters, the imaging optics diameter are preferably about four cm.

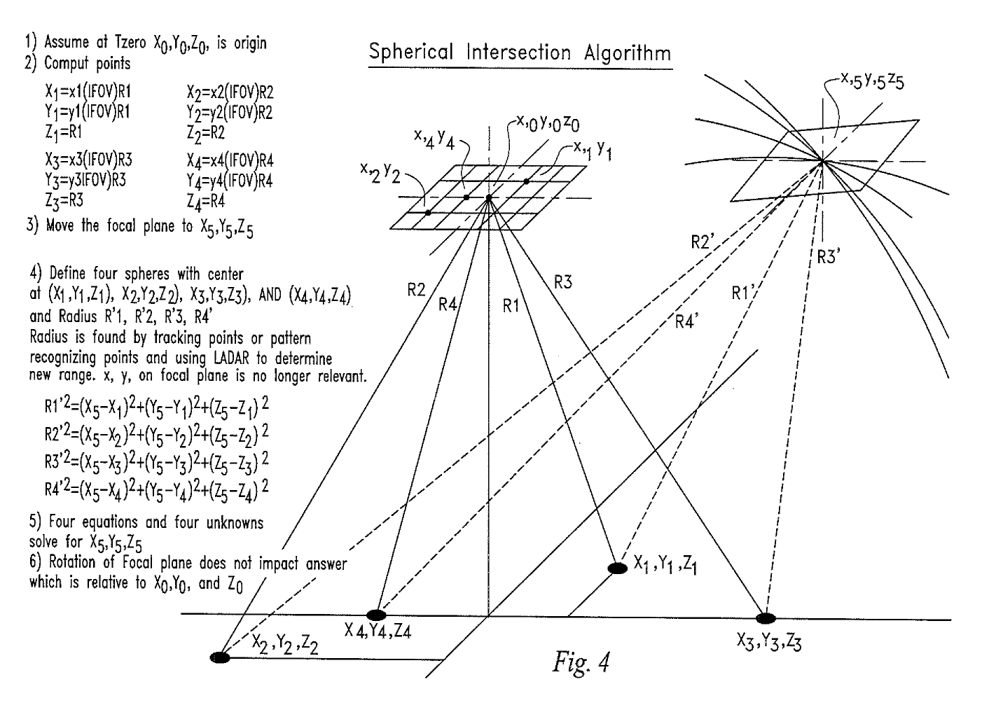

FIG. 3 shows a schematic diagram of the preferred signal processing flow for the sensing system of the invention. The sensor outputs generate x and y values in focal plane coordinates and generate range data for every pixel to the ground or a terrain feature in an image data frame or frame. The sensor also generates an amplitude for every pixel on the FPA.

The first step in a preferred signal processing set of steps of FIG. 3 is to send the image frame data to two high pass filters. In this embodiment, the high pass filters are configured to enhance the edges in the amplitude and range domain.

Very bright or very dark objects in the image data frames flow into a cluster and centroid processing block based on amplitude. Objects that have large range differences over several pixels will flow into another cluster and centroid processing block. A function of these blocks is to rank or “weight” areas in the image data frames and field of view by their signal-to-noise (contrast to noise) characteristics. The weighting table for reference point image data having one or more predetermined weighting characteristics or “weights” is stored in computer memory in a table and updated by the system with clusters of reference points stored that have suitable high contrast image properties for the LIDAR system to track against.

The next block in the signal processing chain is combining the weighted image and range tables into a single memory table of promising clusters of reference point images to track. The best candidates (based on high contrast, high signal to noise rankings or weightings) are presented to the algorithm that computes the sensing system (i.e., host vehicle) motion.

At any point in time, the initial position of the sensor system may be reset by the user. As one or more tracked reference points drift out of the field of view of the sensing system, they are automatically updated by new reference points that are regularly being input in the rank table such that the system always has at least four reference points feeding the vehicle drift algorithm (sometimes referred to as the spherical intersection algorithm).

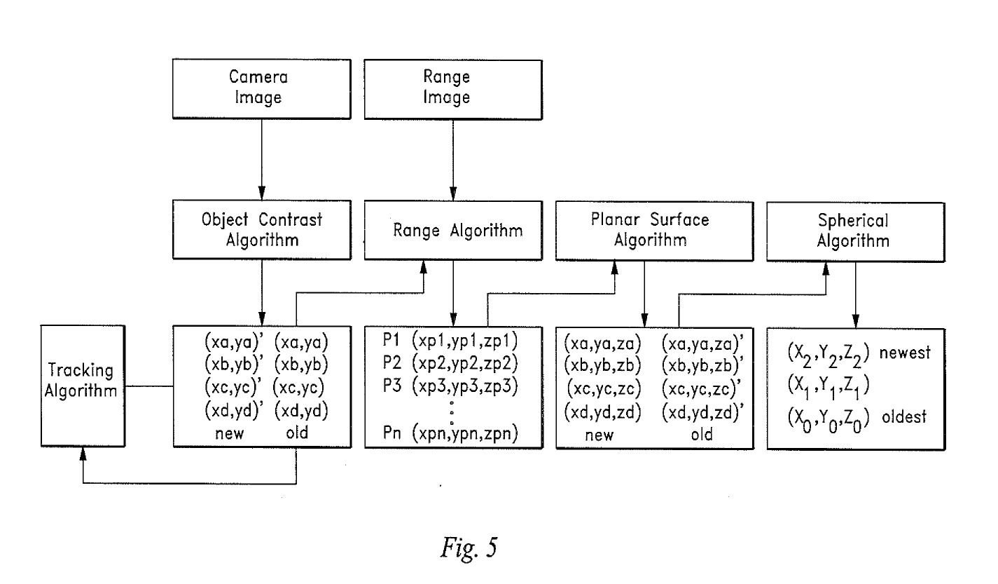

A preferred set of processing steps and algorithm for the sensing system host vehicle travel or motion is shown in FIG. 4.

A host vehicle having the sensing system of the invention disposed thereon is assumed to have an initial position at Xo, Yo, Zo. The preprocessing described above selects at least four reference points that have the highest weighted signal-to-noise ratio and act as feeding trackers. The position of these reference points is computed in the initial position space by knowing the pixel location on the focal plane of the centroid, the IFOV of the pixel and the range. In FIG. 4, the computation of the four tracked centroids in the original focal plane space is shown in step 2.

The host vehicle is assumed to have moved to a new position shown in step 3 in FIG. 4. The orientation of the focal plane is allowed to change. The initial four tracked reference points are known in the original inertial 3-D space. Since these same reference points are being tracked by the system, the range to these points is being computed for every frame.

In step 4 shown in FIG. 4, four spheres are computed by the system that have the tracked reference points as their centers and the ranges to the reference points from the host vehicle as their radii. The intersection of these four spherical equations is the point where the host vehicle has moved in the original 3-D space.

The final step of the spherical intersection algorithm is solving four spherical equations with four unknowns to determine the new position, X₅, Y₅ and Z₅. The calculations used to determine the vehicle position are referred to as trilateration, which is the same methodology used by the GPS to determine the position of a GPS receiver.

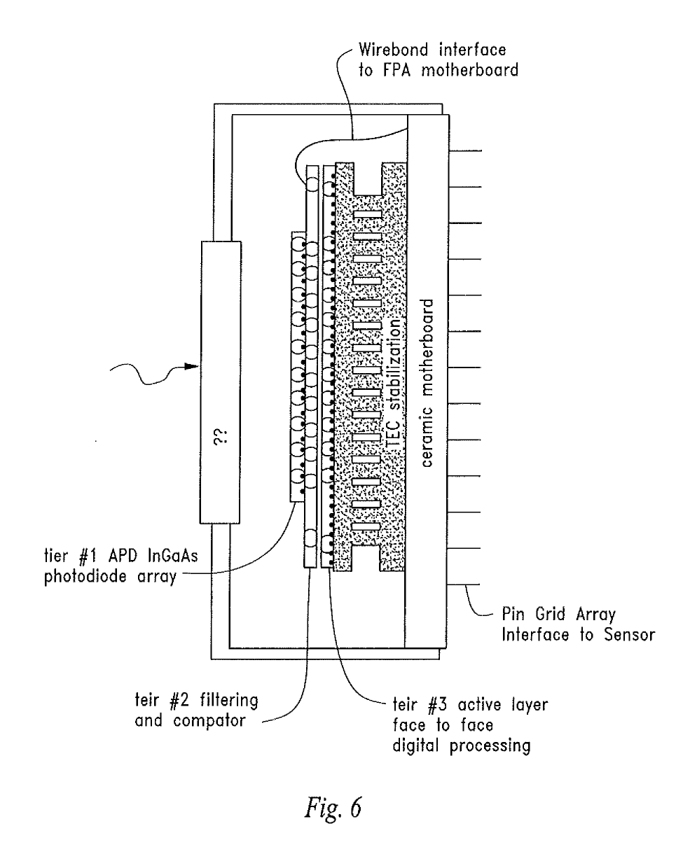

A preferred processing algorithm in a LIDAR algorithm processing flow diagram is illustrated in FIG. 5.

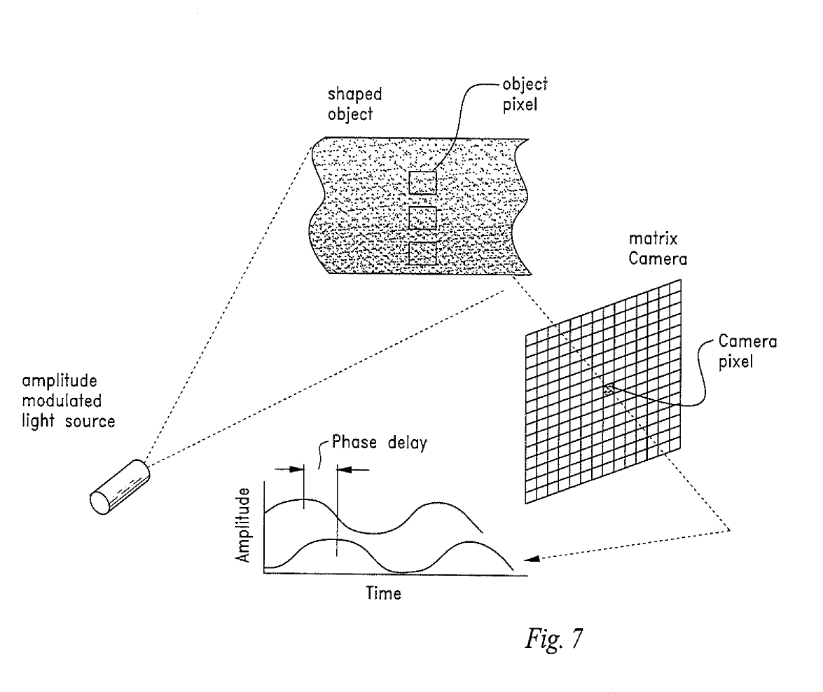

FIG. 6 shows a preferred embodiment of a LIDAR receiver module for use in the sensing system of the invention. In this embodiment, a stack of electrically coupled silicon integrated circuits forming an ROIC module and LIDAR detector chip define major elements of the receiver readout electronics. The layers may include an InGaAs APD detector array, analog/filtering IC and a digital processing IC. The stack of ICs may be placed on a thermoelectric cooler (TEC) to maintain temperature stabilization, and placed inside a sealed ceramic package. A spectral filter or window may be placed on the front active side of the detector array.

The unique features of the illustrated embodiment of the LIDAR receiver are attributed to the ROIC and small pixel output readout circuit unit cell size. The unit cell in a LIDAR ROIC is much more complicated that that of a standard imaging device. The unit cell in a LIDAR must be able to capture the travel time from the laser pulse leaving sensor, Tzero, to the arrival of the echo at the speed of light. Such a unit cell may comprise hundreds or thousands of transistor circuits. Fitting these blocks into a unit cell would typically require a pixel size of 100×100 microns.

By using a stacked die approach, the unit cell can be reduced to 50×50 microns or less. The signal path from layer to layer may be accomplished by through-silicon via (TSV) technology. Through-silicon vias are reliably provided on 1.3 micron centers.

While time of flight LIDAR may be used in the disclosed invention, a phase sensing LIDAR system or the use of a structured light element may also be embodied in the system.

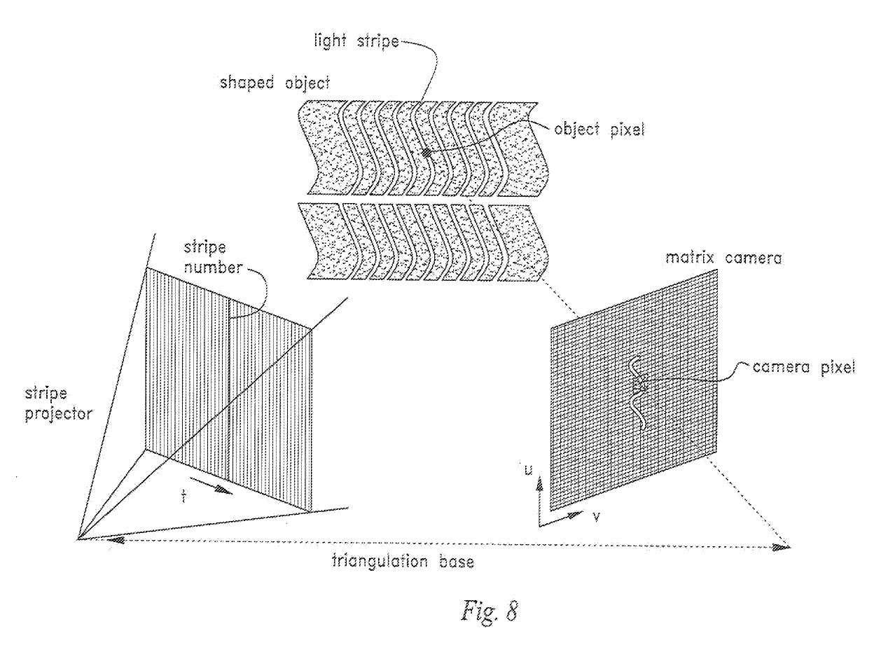

The phase sensing time-of-flight embodiment transmits an amplitude modulated laser light beam onto the ground. The phase of the reflected light is compared to the transmitted laser light at each pixel to calculate a phase delay as is generally depicted in FIG. 7.

The range at each pixel is found by the simple range equation:

$$Range := \frac{c \cdot ( \vert phasedelay \vert \cdot 2 \frac{π}{360} )}{( 4 π f )}$$

where: f is the modulation frequency
and c is the speed of light

There is an ambiguity in range at the point when the {phase delay} goes beyond 360 degrees. That is defined by:

$$Range\_ambiguity := \frac{c}{( 2 \cdot f )}$$

With a modulation frequency of 30 MHz the range ambiguity is five meters, i.e., objects beyond five meters are aliased back to appear much closer. If the field of view can be adjusted such that ranges of five meters are not present, the ambiguity can be ignored. If such ranges do exist, then modulating at two frequencies, 3.0 MHz and 30 MHz permits aliased objects to be identified.

The phase delay can be measured by sampling the return echo in quadrature. This is accomplished by taking four samples during one period of the transmitted waveform. Each sample is timing to coincide with 90-degree phase shift of the transmitted signal. The timing used to generate the transmitted sine wave is also used to generate the sampling signal. The quadrature sampling should occur over multiple return echo periods to increase the signal to noise ratio.

Once the quadrature samples (S0, S1, S2, and S3) for each pixel are obtained numerous parameters can be computed as follows:

arc tan((S0−S2)/(S1−S3)=phase delay of pixel and therefore the range.

sqrt((S1−S3)²+(S0−S2)²)=amplitude of pixel

amplitude*sinc(duty cycle)/((S0+S1+S2+S3)/4)=demodulation factor

The S measurements are a function of the demodulation factor and signal to noise ratio.

The approach here is that the amplitude modulation is typically between 10 to 30 MHz. Thus, in order to detect the phase of each pixel off focal plane, the imager sample rate must be in the MHz range. This requirement may be overcome by sampling on-focal plane in quadrature within each pixel over numerous cycles, then reading out the integrated signal at a normal 30 Hz rate.

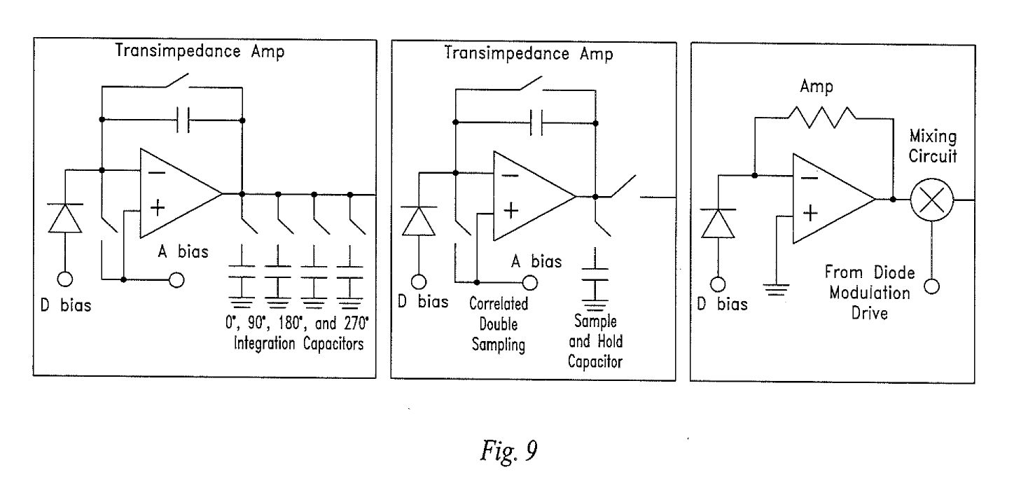

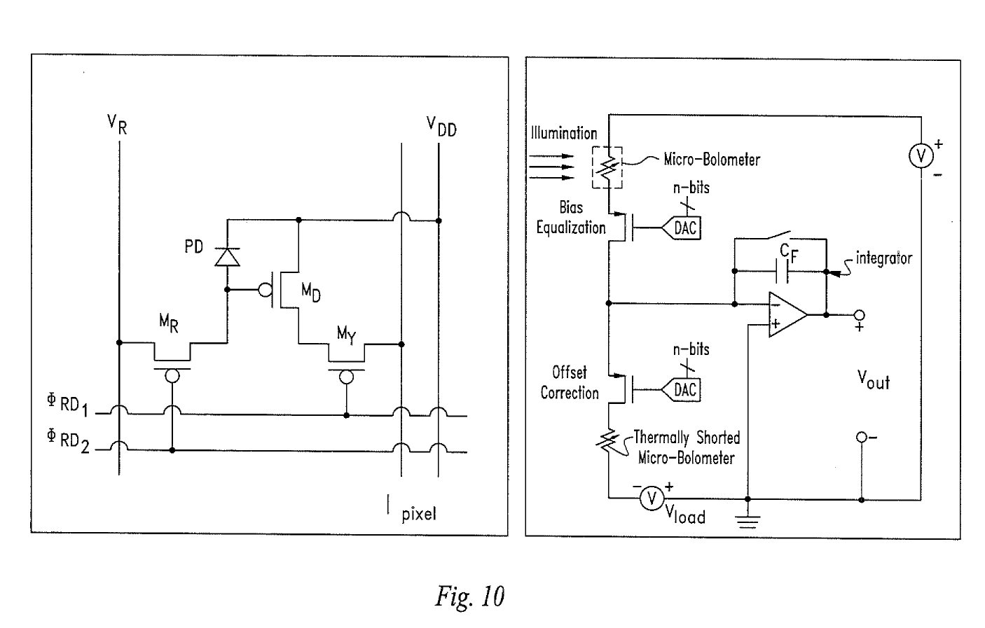

As depicted in FIG. 8, a structured light architecture can be implemented in the invention using a conventional visible focal plane array. In this approach, a pattern of light is projected onto the scene and the reflected light read out using a conventional visible focal plane array. The projected or structured image can be in the form of lines or phase modulated line images. In this embodiment, additional off-focal plane processing is preferred including Fourier transform computations.

For the phase-sensing time of flight technique, on-focal plane processing is used to achieve the requisite sample rate. Typical the phase-sense time of flight needs to sample the modulated illumination scene at four times the modulation frequency to determine the phase of the return echo. Without on focal plane signal processing, the FPA sample rate would be expected to be above four MHz, thus relatively fast, expensive cameras are best used to achieve this rate.

With on-focal plane processing, this rate can be relaxed to the more traditional video rates of 30 to 60 Hz. The on-focal plane signal processing does, however, drive focal plane architecture complexity.

In FIG. 8, three alternative exemplar focal plane architectures are depicted that may be used to reduce the focal plane sample rate in a phase-sensing embodiment of the invention, yet provide the ability to determine the echo phase in a phase time of flight embodiment.

In essence, four samples have to be captured at 90-degree separation in the transmitting frequency space. The samples are ideally integrated in quadrature over many cycles of the transmitted beam. This builds signal and reduces noise. At the end of the integration period, there are four signals, one each at 0, 90, 180, and 270-degrees phase.

These four values can then be used to determine both the amplitude and phase of the detected signal. Each of the architectures in this embodiment comprises an amplifier to provide gain. Two of the architectures include a storage capacitor to store the signal.

In the first embodiment, all four phase samples are stored in the unit cell. At the end of the integration period these four signals are readout. The integration period could be as long as 33 milliseconds.

In the second embodiment, only one storage capacitor is used. The signal must be read from the unit cell at four times the transmitted modulation frequency but only to a secondary memory off of the unit cell but within the FPA. After a given integration period (typically 33 milliseconds), the multiple samples can be read out of the FPA.

In the third embodiment, the output of the amplifier is mixed with a small portion of a phase delayed transmitted waveform. The phase delay of the modulated signal that maximizes the output is the phase delay due to the range.

In the structured light embodiment, a commercial off the shelf or “COTS” FPA architecture can be used to obtain 3-D imagery for the system, i.e., a COTS visible sensor as an adjunct sensor and a micro-bolometer camera as the main 3-D imaging device.

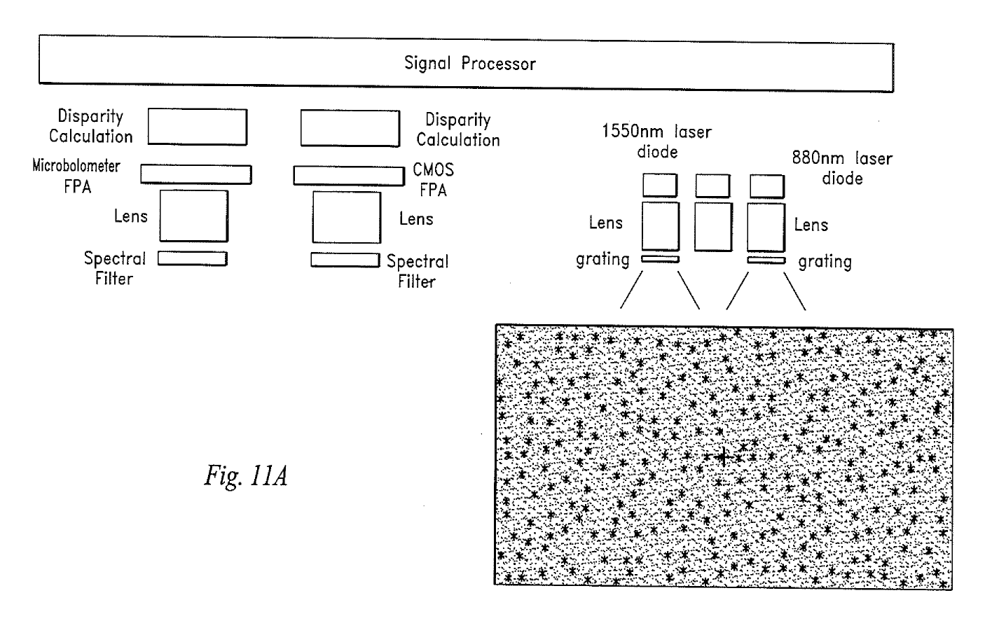

FIG. 10 shows an FPA unit cell of a three transistor visible focal plane and a micro-bolometer unit cell.

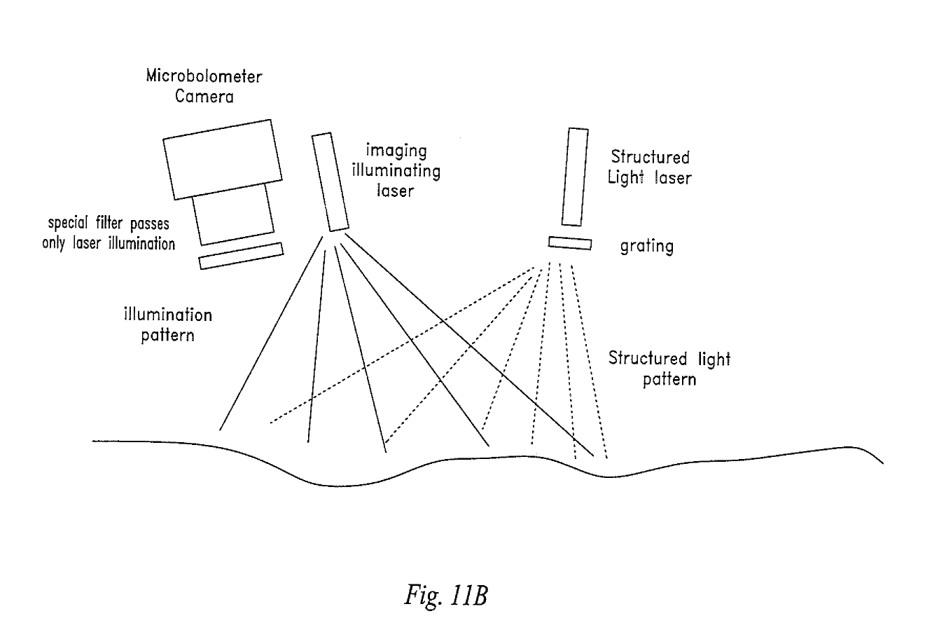

The sensor architecture of the structured light 3-D imager embodiment is shown in FIGS. 11A and 11B.

A micro-bolometer camera is used to obtain both the structured light signal and the imagery signal. Two laser diodes are used to provide the illumination. One diode is transmitted through a diffraction grating. This produces the structure light as a pattern of bright spots. The second laser diode provides uniform illumination. The diodes are operated alternately.

First the structured light signal is transmitted and captured by the micro-bolometer camera. Next the uniform illumination diode transmits its signal and the image is captured by the micro-bolometer camera. The signal processing computes the disparity between the dot pattern generated during a factory calibration, stored in memory, and the currently captured structured light image. The image data is fed into the signal processor to determine the highest contrast points or clusters to be used in camera motion calculations.

The micro-bolometer will have a narrow line spectral filter in its optical path to block the ambient light. This allows the structured light image to be transmitted with much lower intensity.

This embodiment permits a standard CMOS camera to be used as an adjunct camera and to be operated only during the daylight, dawn and dusk periods. A standard CMOS camera may be used to capture imagery during these periods, thus eliminating the need to turn on the laser diode that provides illumination to the micro-bolometer camera. At night the CMOS camera is not used and the micro-bolometer captures the imagery using the uniform illumination laser diode.

The structured light 3D camera technique's niche is in short range (0.5 to 5 meters), moderate light applications. A consumer version has been mass produced for under $200 by Microsoft as the gaming Kinect sensor. The limiting factor for using the structured light technique in military applications is that it works best on moderate light conditions.

Indoor lighting levels or twilight and dusk are well-suited lighting conditions for this embodiment. The reason moderate light levels are well-suited lies in the fact that enough light is available for the imaging camera and the projected structured light pattern does not have to compete with the sun to be captured by the structured light camera. Trying to see that projected light pattern during the day is similar to trying to observe a flashlight beam during the day. The mid-day sun is approximately 5 f-stops brighter than typical room light.

Two approaches may be used to overcome the bright ambient light when projecting structured light. First is to move the projected light into a wavelength outside the imaging camera band. Second is to illuminate the structured light pattern with a laser. This allows the structured light camera to use a very narrow band spectral filter in its optical path to reject the imaging wavelengths but allow the full laser energy to pass into the structured light camera. The Kinect sensor uses these approaches to operate within typical room light situations. The structured light camera is operated at 880 nm, which is outside the imaging camera's 450 to 750 nm wavelength band.

The ambient light from the sun is suppressed as the wavelength increases. Furthermore a transmission trough exists at 1.39 microns, meaning the sun illuminates the ground very weakly. However even 1.5 microns the sun intensity is less.

The sensor may be designed to operate between 1.3 and 1.55 microns. Moving to this wavelength has the negative implication of not allowing a typical CMOS sensor to act as the structured light camera. A logical choice for the camera is an InGaAs camera as these devices are tailored to operate between 1.1 and 1.7 microns. However InGaAs cameras are typically greater than $20,000 and an alternative is to use a micro-bolometer camera.

Micro-bolometer cameras use an FPA detector that is sensitive to all wavebands, but are traditionally used in the 8-12 micron band because that band has the most thermal energy. The advantage of the micro-bolometer camera is its lower cost (several thousands of dollars) as compare to InGaAs cameras (tens of thousands of dollars).

The newest wafer-scale packaged micro-bolometer focal planes have silicon windows instead of germanium which allows sensitivity to all wavelengths down to one micron. Thus the structured light camera can be designed with a micro-bolometer camera, silicon window and normal glass optics. A spectral filter may be used to only allow light in a very narrow band around the laser illuminator frequency.

In this alternative embodiment, only one camera is used to function as both the structured light camera and the imaging camera. The micro-bolometer camera is able to see any imaging information at 1.5 microns, because the sun illumination and any thermal emission are too weak at this wavelength. The system provides an illuminating laser that works in conjunction with the structured light projection laser.

During half of the micro-bolometer's duty cycle, it images the structured light projection pattern, during the second half of its duty cycle; it operates as an imaging device with a flow beam from a second laser. The beam allows the micro-bolometer to form an image of the ground.

It is calculated that a 40 mW laser is sufficient to illuminate the ground for imaging. Using this method only one camera is required but two transmitting lasers each operating at 50% of the time.

Camera position has been analyzed in terms of translation and tilt in order to quantify error bounds. The translation equations follow a similar theory to GPS tracking equations.

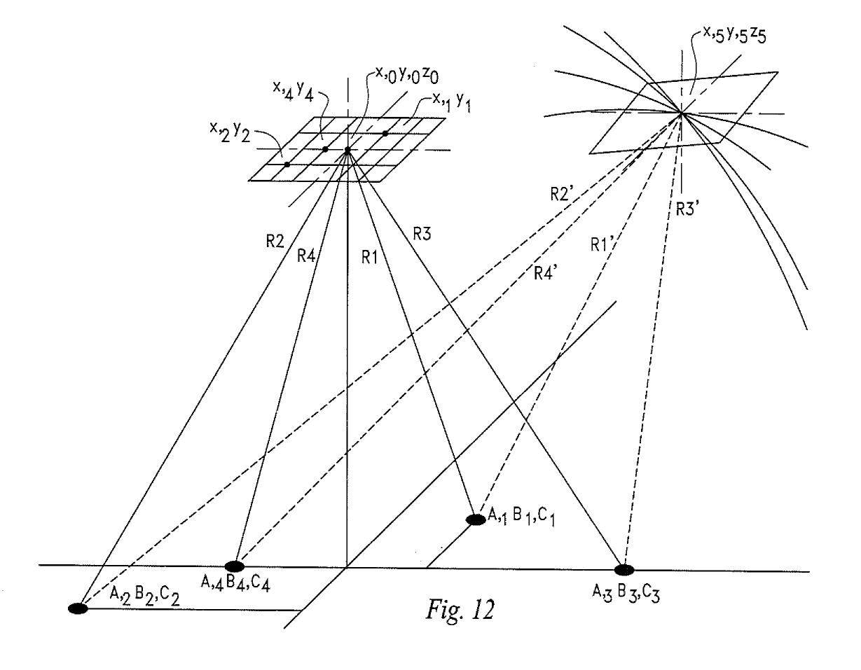

From each point in the sensor's field of view, a sphere can be generated with a radius equal to the range from the point on the ground in the FOV to the focal plane's new location. The numerous spheres all intersect at the focal plane's X₁, Y₁, Z₁, coordinate points as illustrated in FIG. 12.

From the four spherical equations below, only the X₁, Y₁, and Z₁ (the new translation location of the focal plane) values are unknown.

R1′²=(X₁−A₁)²+(Y₁−B₁)²+(Z₁−C₁)²

R2′²=(X₁−A₂)²+(Y₁−B₂)²+(Z₁−C₂)²

R3′²=(X₁−A₃)²+(Y₁−B₃)²+(Z₁−C₃)²

R4′²=(X₁−A₄)²+(Y₁−B₄)²+(Z₁−C₄)²

The three points (ABC)₁, (ABC)₂ and (ABC)₃ are known from the starting position computation that (ABC)₁ for example is equal to (x1*IFOV*R1, y1*IFOV*R1, R1)′.

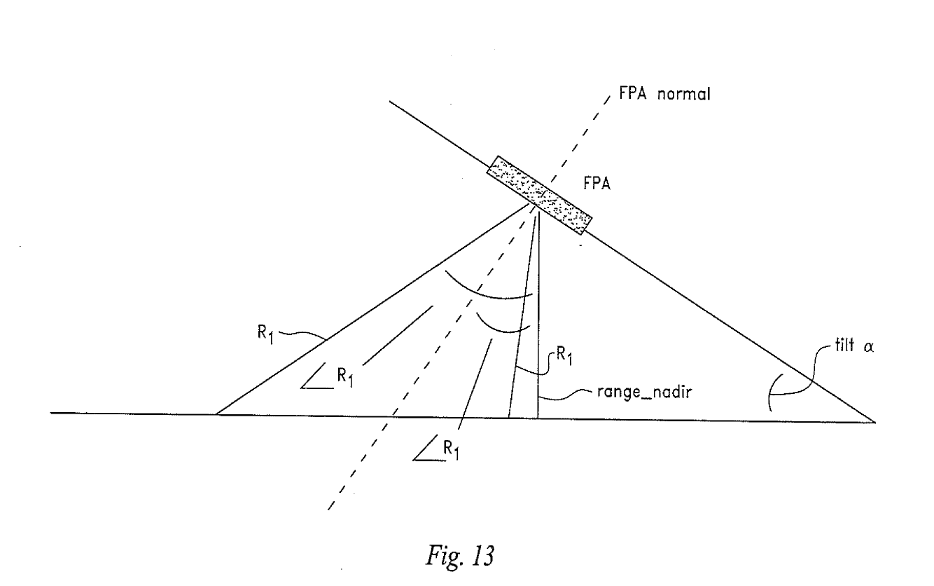

Range is also used to compute the tilt in camera in the X and Y axis. In the example of FIG. 13, the only unknown is the tilt angle α in each axis.

$$α = {tan}^{- 1} [ ( \frac{{R}_{1} + {R}_{- 1}}{{R}_{1} - {R}_{- 1}} ) tan β ]$$

Finally, the azimuth is computed after the coordinate transformations above based on how many pixels the sensor has rotated since its initialization point. The structured light cameras have an advantage for azimuth determination since they allow smaller and more pixels.

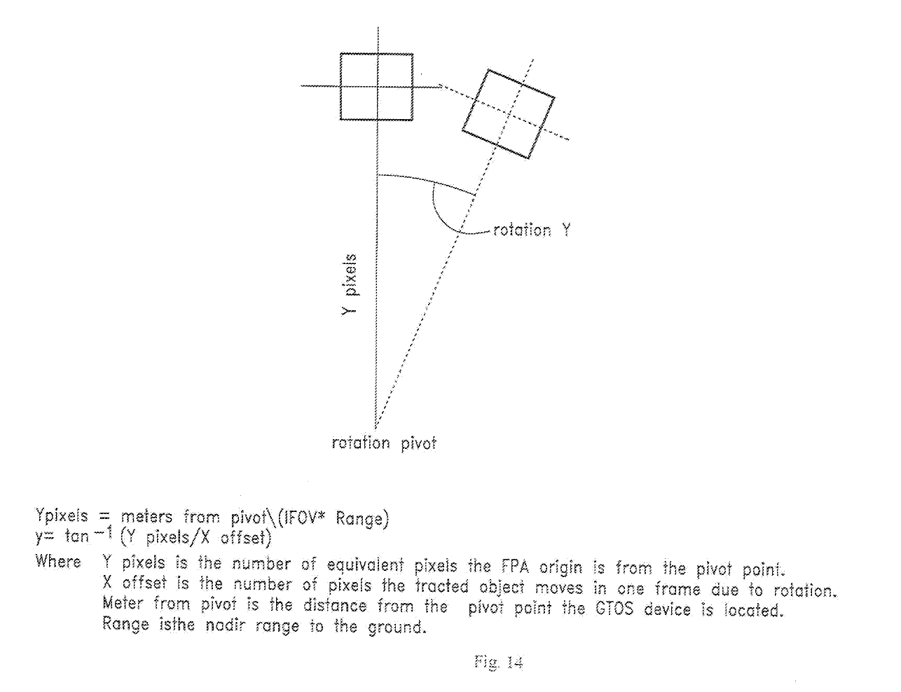

FIG. 14 illustrates exemplar azimuth determinations using nadir range to determine the azimuth rotation.

“Star mapping” may come into play when the sensing system is moved violently to a new position, such as may take place during the recoil of a weapon fire, or if the field of view is momentarily blocked during motion by the operator.

The track points within the tracking stack form a specific pattern on the focal plane, just as a star field will form a specific pattern on the focal plane of a satellites star tracker. When the tracking is lost due to recoil or camera blockage, the pattern in the tracking stack can be pattern matched to all the high contrast points on the focal plane.

This is analogous to a star mapping camera matching its pattern recorded on the focal plane to a star map stored in the satellites memory. When this pattern is located in the focal plane, the original points in the tracing stack can be recovered in their new position.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. A tracking and motion sensing system comprising:
sensor and range calculating circuitry configured to detect and calculate each of a plurality of ranges relative to the sensor of each of a plurality of features in a scene wherein the features define each of a plurality of reference points that are representative of the features within an image data frame that is representative of the scene,
trilateration calculating circuitry configured to calculate a three-dimensional point location relative to the sensor in a three-dimensional space from the plurality of reference points.

2. The sensing system of claim 1 wherein the trilateration calculating circuitry is further configured to calculate a sensor travel distance using two of the three-dimensional point locations calculated from two separate image data frames.

3. The sensing system of claim 2 comprising a time-of-flight LIDAR system.

4. The sensing system of claim 2 comprising a phase-sensing LIDAR system.

5. The sensing system of claim 2 comprising a structured-light three-dimensional scanning element comprising a projected light pattern source and a visible imaging camera system configured to measure a three-dimensional object.

6. The sensing system of claim 2 wherein at least one of the reference points is selected from a plurality of weighted reference points stored in electronic memory and ranked using at least one predetermined image feature characteristic.

7. The sensing system of claim 2 wherein the plurality of first reference points comprises at least four.

8. The sensing system of claim 2 where the plurality of second reference points comprises at least four.

9. The sensing system of claim 2 where the plurality of first and second reference points each comprises at least four.
